(19) United States
(12) Patent Application Publication
(10) Pub. No.: US 2026/0319421 A1
(43) Pub. Date: Oct. 15, 2026

(54) SHEET FEEDING APPARATUS AND IMAGE FORMING APPARATUS

(71) Applicant: CANON KABUSHIKI KAISHA, Tokyo (JP)

(72) Inventor: RYOSUKE KASAHARA, Ibaraki (JP)

(21) Appl. No.: 19/542,749

(22) Filed: Feb. 18, 2026

(30) Foreign Application Priority Data
Apr. 14, 2025 (JP) 2025-066285

(51) Int. Cl. G03G 15/00

(52) U.S. Cl. CPC G03G 15/6511; G03G 15/5016; G03G 2215/00611

(57) ABSTRACT

A controller that controls a drive portion based on detection results of a first detecting portion and a second detecting portion executes a first lift-up operation of lifting a stacking portion from a lower position to the feeding position at a first speed, a first lift-down operation of lowering the stacking portion below the feeding position after the first lift-up operation, and a second lift-up operation of lifting the stacking portion to the feeding position at a second speed slower than the first speed after the first lift-down operation, and in a case where the first detecting portion and the second detecting portion are in a detection state when the first lift-down operation is executed, the controller notifies to confirm the sheet to be stacked in the stacking portion.

### BACKGROUND

### Field of the Technology

The present disclosure relates to a sheet feeding apparatus and an image forming apparatus.

### Description of the Related Art

In the related art, a sheet feeding apparatus that feeds a sheet to an image forming apparatus performs an operation of lifting up a lifter plate on which sheets are stacked after feeding, and adjusts a sheet surface height of an uppermost sheet to a predetermined position. In this case, the shorter the lift-up time, the higher the usability. Therefore, it is desirable to perform the lift-up at a high speed.

In such a sheet feeding apparatus, when a user performs feeding in a state in which more sheets than a specified number of sheets are stacked on a tray that is a cassette (hereinafter, referred to as an overloaded state), the feeding is performed in a state in which the sheet surface height is higher than the ideal. In this case, there is a concern that double feeding may occur due to poor sheet separation or the occurrence rate of jams may be increased.

Therefore, Japanese Patent Application Laid-Open No. 2011-63344 discloses a configuration provided with a detecting portion that detects a sheet surface position of a sheet stacked on a lifter plate in a tray, and a detecting portion that detects that the lifter plate is at a lower limit position, in which in a case where both of the detecting portions are in a detection state before the tray is closed with respect to the apparatus, it is determined that sheets are overloaded and feeding is prohibited.

However, in a case where the sheets cannot be properly installed inside the tray, the sheets inside the tray may be misaligned by an operation of lifting up the lifter plate after closing the tray with respect to the apparatus. In this case, if the sheets are fed in a state of being misaligned, sheet separation cannot be stably performed, and a jam or double feeding may occur.

### SUMMARY

According to an aspect of the present disclosure, provided is a sheet feeding apparatus including: a storage portion configured to store a sheet; a feeding portion configured to feed the sheet stored in the storage portion; a stacking portion that can be lifted or lowered and on which the sheet stored in the storage portion is stacked; a first detecting portion configured to detect that the sheet stacked on the stacking portion is at a feeding position at which the sheet is fed by the feeding portion; a second detecting portion configured to detect that the stacking portion is at a lower position lower than the feeding position; a drive portion for lifting or lowering the stacking portion; and a controller configured to control the drive portion based on detection results of the first detecting portion and the second detecting portion, in which the controller executes a first lift-up operation of lifting the stacking portion from the lower position to the feeding position at a first speed, a first lift-down operation of lowering the stacking portion below the feeding position after the first lift-up operation, and a second lift-up operation of lifting the stacking portion to the feeding position at a second speed slower than the first speed after the first lift-down operation, and in a case where the first detecting portion and the second detecting portion are in a detection state when the first lift-down operation is executed, the controller notifies to confirm the sheet to be stacked in the stacking portion.

According to the present disclosure, it is possible to previously eliminate a state in which feeding cannot be normally performed by making a notification prompting a check of an internal status of a storage portion.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram of a sheet feeding apparatus;

FIG. 2 is a block diagram illustrating an example of the sheet feeding apparatus;

FIG. 3A is a side view of a tray, FIG. 3B is a top view of the tray, and FIG. 3C is a front view of the tray;

FIG. 4 is a schematic diagram of a lifting/lowering operation in the sheet feeding apparatus;

FIG. 5 is a schematic diagram of a lifting/lowering operation in the sheet feeding apparatus;

FIG. 6 is a diagram showing an example of display that notifies a user;

FIG. 7 is a flowchart showing an operation of a sheet feeding apparatus according to a first embodiment;

FIG. 8 is a flowchart for a case where a lifter plate is subjected to coarse lift-up;

FIG. 9 is a flowchart for a case where the lifter plate is subjected to coarse lift-down;

FIG. 10 is a flowchart for a case where the lifter plate is subjected to fine lift-up; and

FIG. 11 is a flowchart showing an operation of a sheet feeding apparatus according to a second embodiment.

### DESCRIPTION OF THE EMBODIMENTS

Hereinafter, embodiments of the present disclosure will be described with reference to the drawings. Note that dimensions, materials, shapes, relative arrangements, and the like of components described in the following embodiments are merely examples, and the scope of the present disclosure is not intended to be limited only to these.

### First Embodiment

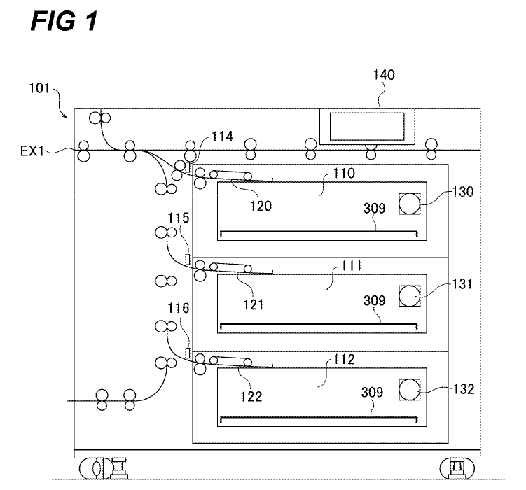

A sheet feeding apparatus according to a first embodiment will be described with reference to FIG. 1. FIG. 1 is a schematic cross-sectional view showing a configuration of a sheet feeder 101 as the sheet feeding apparatus according to the first embodiment.

The sheet feeder 101 is detachably mounted on an image forming apparatus and feeds a paper sheet to the image forming apparatus.

In the following embodiment, a sheet feeding apparatus that is detachable from an image forming apparatus will be described as an example, but the present disclosure is not limited thereto. For example, a sheet feeding apparatus integrally included in an image forming apparatus may be used.

In the first embodiment, an example will be described of control for providing a display prompting a check of a sheet tray in a case where both a sheet surface position detecting sensor as a first detecting portion and a lower limit position detecting sensor as a second detecting portion are in a detection state during coarse lift-down control. By prompting a user to check the sheet tray, the user is notified of the occurrence of paper drag on the sheets stacked in the sheet tray.

### Configuration Diagram of Sheet Feeder

The sheet feeder 101 is provided with sheet trays 110, 111, and 112 as storage portions, sheet feeding belts 120, 121, and 122 as feeding portions, and a sheet lifter plate 309 as a stacking portion.

The sheet feeder 101 is provided with a plurality of the sheet trays 110, 111, and 112. Each of the sheet trays 110, 111, and 112 is configured to be openable and closeable to the front side toward the sheet feeder 101 shown in FIG. 1. Various sheets to be used for printing are stored in the sheet trays 110, 111, and 112, and are stacked and held on the sheet lifter plate 309. Each of the sheet trays 110, 111, and 112 is configured so that it can be pulled out to the front side.

The uppermost sheet of the sheets stacked in the sheet tray 110, which is a sheet at the uppermost position, is floated by a fan, and the sheets are fed by the sheet feeding belt 120 one by one. A double feeding detecting sensor 114 performs sensing from the leading end of a fed sheet, and detects whether a plurality of sheets is simultaneously fed, and the amount of misalignment of sheets being conveyed in a case where they are double-fed. Similarly, the sheets stacked in the sheet trays 111 and 112 are fed one by one by the sheet feeding belts 121 and 122, respectively, and double feeding detecting sensors 115 and 116 detect whether the sheets are double-fed, and the amount of misalignment of sheets being conveyed in a case where they are double-fed. The fed sheets are then conveyed toward a sheet ejection port EX1 by each conveying roller.

The sheet trays 110, 111, and 112 include tray opening/closing buttons 130, 131, and 132, respectively. To open the sheet trays 110, 111, and 112, the tray opening/closing buttons 130, 131, and 132 are pressed, and the sheet tray corresponding to the button is opened. For the sheet tray in which the tray opening/closing button has been pressed, the sheet lifter plate 309 is lowered to the lower limit position, and the sheet tray is then opened to the front side.

The sheet feeder 101 is provided with a display panel 140 as a display portion. The display panel 140 displays the internal status of the trays, such as whether each of the sheet trays 110, 111, and 112 is empty, overloaded, or available in a list.

### Block Diagram of Sheet Feeder

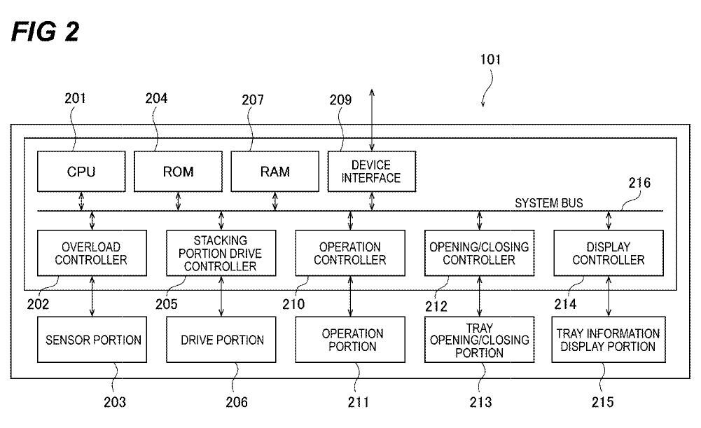

FIG. 2 is a block diagram illustrating a configuration of the sheet feeder 101 according to the present embodiment. A CPU 201 as a controller is mounted on the sheet feeder 101, and controls the operation of the sheet feeder 101. A program describing the processing content of the present embodiment is stored in a ROM 204, and installed in the sheet feeder 101. The CPU 201 reads the program recorded in the ROM 204 into a RAM 207 and executes the program.

The CPU 201 is connected to an overload controller 202, a stacking portion drive controller 205, an operation controller 210, an opening/closing controller 212, a display controller 214, and a device interface 209 to be described later via a system bus 216, and performs overall control.

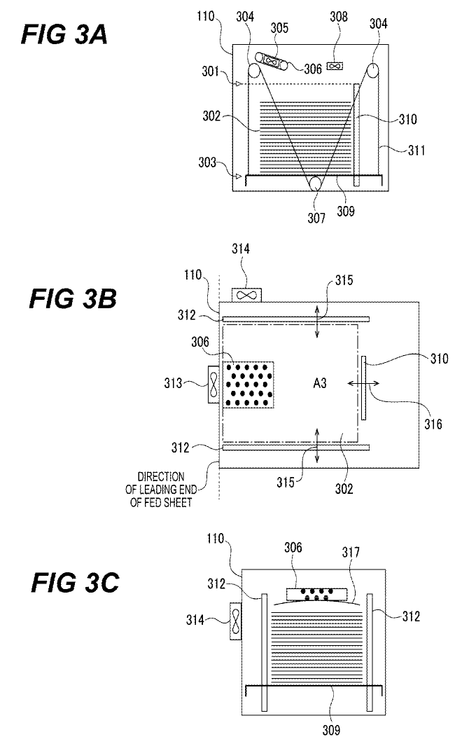

The overload controller 202 is connected to a sensor portion 203, and determines whether overload has occurred on the basis of a detection result of the sensor portion 203. The sensor portion 203 includes a sheet surface position detecting sensor 301 and a lower limit position detecting sensor 303 shown in FIG. 3, and a tray close sensor, which are disposed in each of the sheet trays 110, 111, and 112 of the sheet feeder 101.

The stacking portion drive controller 205 is connected to a drive portion 206, and controls a motor disposed in each of the sheet trays 110, 111, and 112 of the sheet feeder 101. The drive portion 206 includes motors that drive the sheet feeding belts 120, 121, and 122, the sheet lifter plate 309 shown in FIG. 3, and fans such as a front sheet feeding fan 313 and a side sheet feeding fan 314.

The device interface 209 is an interface portion with a controller, and is responsible for input and output of device information acquired by the sheet feeder 101. Examples of the controller mentioned here include a controller included in an external device such as an image forming apparatus connected to the sheet feeder 101 or a host computer connected to the sheet feeder 101.

The operation controller 210 is connected to the operation portion 211, and controls the tray opening/closing buttons 130, 131, and 132 respectively disposed in the sheet trays 110, 111, and 112 of the sheet feeder 101. The operation portion 211 includes the tray opening/closing buttons 130, 131, and 132.

The opening/closing controller 212 is connected to the tray opening/closing portion 213, and controls opening/closing of the sheet trays 110, 111, and 112 of the sheet feeder 101. The tray opening/closing portion 213 includes a tray opening/closing solenoid.

The display controller 214 is connected to a tray information display portion 215, and displays the status of the sheet trays 110, 111, and 112 of the sheet feeder 101. The tray information display portion 215 includes the display panel 140.

### Schematic Configuration Diagram of Sheet Tray

Next, a schematic configuration of the sheet tray 110 provided in the sheet feeder 101 will be described. FIGS. 3A-3C are schematic configuration diagrams of the sheet tray 110 provided in the sheet feeder 101. The sheet trays 111 and 112 have the same configuration as the sheet tray 110. FIG. 3A is a side view of the sheet tray 110, FIG. 3B is a top view of the sheet tray 110, and FIG. 3C is a front view of the sheet tray 110.

The sheet tray 110 includes a tray lifting/lowering mechanism, a sheet installation position regulating mechanism, and a sheet separating mechanism to be described below. The tray lifting/lowering mechanism, the sheet installation position regulating mechanism, and the sheet separating mechanism of the sheet tray 110 will be described with reference to FIGS. 3A-3C.

### Tray Lifting/Lowering Mechanism

The tray lifting/lowering mechanism will be described with reference to FIG. 3A that is a side view of the sheet tray 110.

The sheet lifter plate 309 is stored in the sheet tray 110, can be lifted or lowered, and is configured so that the sheets stored in the sheet tray 110 are stacked thereon. In order to lift and lower the sheet lifter plate 309, a lift wire 311 is connected to the sheet lifter plate 309, and the lift wire 311 is connected to a winding pulley 307 via a suspension pulley 304. The winding pulley 307 is driven by a lift motor of the drive portion 206, and winds or unwinds the lift wire 311. By rotating the lift motor in a normal rotation direction, the winding pulley 307 winds the lift wire 311 and lifts the sheet lifter plate 309. In contrast, by rotating the lift motor in a reverse rotation direction, the winding pulley 307 unwinds the lift wire 311 and lowers the sheet lifter plate 309.

In order to set the lifting/lowering range of the sheet lifter plate 309, the sheet tray 110 is provided with the sheet surface position detecting sensor 301 as a first detecting portion and the lower limit position detecting sensor 303 as a second detecting portion.

The sheet surface position detecting sensor 301 is a first detecting portion that detects that the sheet surface position of sheets 302 stacked on the sheet lifter plate 309 is at a height at which the uppermost sheet can be separated and fed. In other words, the sheet surface position detecting sensor 301 detects that the sheet stacked on the sheet lifter plate 309 is at a sheet surface position (feeding position) at which the sheet is conveyed by a conveying belt 306. The sheet surface position detecting sensor 301 detects ON in a case where the height of the sheet 302 or the sheet lifter plate 309 is equal to or higher than the height of the sheet surface position.

The lower limit position detecting sensor 303 is a second detecting portion that detects that the sheet lifter plate 309 has moved to a lower limit position lower than the sheet surface position. The lower limit position detecting sensor 303 detects ON in a case where the sheet lifter plate 309 is at the lower limit position.

The sheet lifter plate 309 is controlled to be lifted and lowered between the position where the sheet surface position detecting sensor 301 detects ON and the position where the lower limit position detecting sensor 303 detects ON.

In addition, the CPU 201 is configured to be able to detect the closing of the sheet tray 110 by using a tray closing sensor. The sheet tray 110 is configured so that a latch holding the sheet tray 110 in a closed state is released and the tray is opened by driving the solenoid.

### Sheet Installation Position Regulating Mechanism

The sheet installation position regulating mechanism will be described with reference to FIG. 3A as a side view, FIG. 3B as a top view, and FIG. 3C as a front view of the sheet tray 110.

The sheet tray 110 is provided with a regulating portion that regulates the position of an end portion of the sheet stacked on the sheet lifter plate 309. As the regulating portion, a rear end regulating plate 310 as a rear end regulating portion and a side regulating plate 312 as a side regulating portion are provided.

As shown in FIG. 3B, the side regulating plate 312 can be freely moved and supported in a direction indicated by a moving direction 315. The side regulating plate 312 regulates the position of the end portion in a width direction orthogonal to a feeding direction of the sheet stacked on the sheet lifter plate 309.

The rear end regulating plate 310 can be freely moved and supported in a direction indicated by a moving direction 316. The rear end regulating plate 310 regulates a rear end that is an upstream end portion in the feeding direction of the sheet stacked on the sheet lifter plate 309.

The side regulating plate 312 and the rear end regulating plate 310 are moved and supported to abut against the sheets 302 stacked on the sheet lifter plate 309, whereby the position of the sheets 302 can be regulated.

In a case where a user stacks the sheets 302, the sheet is abutted against a downstream end portion (leading end) in the feeding direction of the conveying belt 306 in the sheet tray, and stacked on the sheet lifter plate 309. In this case, the position of the sheet 302 is regulated using the side regulating plate 312 that prevents the deviation in the width direction and the rear end regulating plate 310 that prevents the deviation in the feeding direction so that the sheet 302 does not deviate in the width direction or the feeding direction.

As shown in FIG. 3A, the upper end of the rear end regulating plate 310 is set at a position not interfering with a second suction fan 308. Specifically, the upper end of the rear end regulating plate 310 has the same height (height indicated by the broken line) as the height at which the sheet surface position detecting sensor 301 is turned on.

As shown in FIG. 3C, the upper end of the side regulating plate 312 is set higher than an uppermost sheet 317 sucked to the conveying belt 306.

### Sheet Separating Mechanism

The sheet separating mechanism will be described with reference to FIG. 3A as a side view, FIG. 3B as a top view, and FIG. 3C as a front view of the sheet tray 110.

The sheet separating mechanism separates the sheet in a state in which the sheet stacked on the sheet lifter plate 309 is positioned at a sheet feeding position at a sheet surface height at which feeding is possible.

The sheet feeding belt 120 is provided in an upper portion of the sheet tray 110, and has the conveying belt 306 that sucks and conveys the uppermost sheet floated by blowing air to the sheet stored in the sheet tray 110.

As shown in FIG. 3A, the sheet tray 110 is provided with a suction fan 305 and the second suction fan 308. The suction fan 305 is a fan that is inside the conveying belt 306 and sucks the sheet to the conveying belt 306. The second suction fan 308 is a fan that assists the suction of a long sheet that is long in the feeding direction to the conveying belt 306.

Similarly to the sheet feeding belt 120, the second suction fan 308 is provided in the upper portion of the sheet tray 110 on the upstream side of the sheet feeding belt 120 in the feeding direction.

As shown in FIG. 3B, the sheet tray 110 is provided with a front sheet feeding fan 313 and a side sheet feeding fan 314. The front sheet feeding fan 313 is a blowing fan that blows air from the downstream side (leading end side) in the feeding direction to the sheets 302 stacked on the sheet lifter plate 309 and separates the sheets. The side sheet feeding fan 314 is a blowing fan that blows air from the back side (side end side) of the sheet tray to the sheets 302 stacked on the sheet lifter plate 309 and separates the sheets.

The sheet feeding fans and the suction fans are driven by fan motors of the drive portion 206.

When the sheet is separated, first, the fan motor of the front sheet feeding fan 313, which is a blowing fan, is driven to blow air to float the uppermost sheet 317 of the sheets 302 stacked on the sheet lifter plate 309. Thereafter, the fan motors of the suction fan 305 and the second suction fan 308 are driven in order to suck the floated uppermost sheet 317 to the conveying belt 306.

As shown in FIG. 3C, the upper end of the side regulating plate 312 is set higher than the uppermost sheet 317 sucked to the conveying belt 306. By driving the conveying belt 306 by a belt motor of the drive portion 206, the uppermost sheet 317 sucked to the conveying belt 306 is sent from the sheet feeder 101 to the image forming apparatus while the end portion of the uppermost sheet 317 in the width direction is regulated by the side regulating plate 312.

### Schematic Diagram of Lifting/Lowering Operation in Sheet Tray

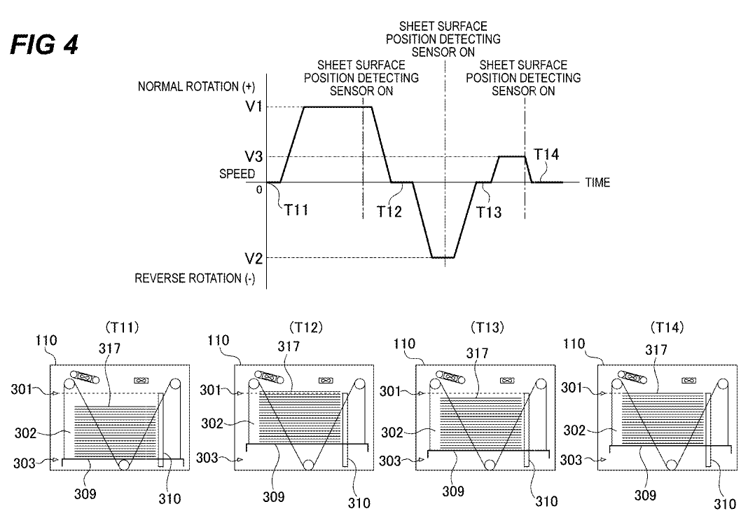

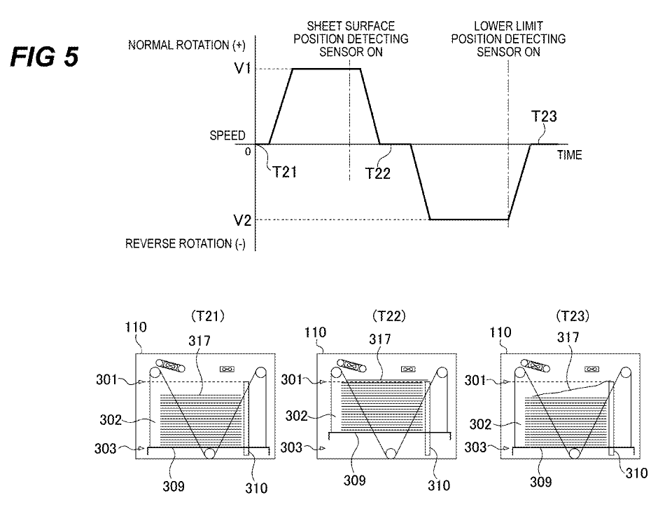

A lifting/lowering operation in the sheet tray 110 will be described with reference to FIGS. 4 and 5. FIGS. 4 and 5 are schematic diagrams of a lifting/lowering operation in the sheet tray 110 provided in the sheet feeder 101. The lifting/lowering operation in the sheet trays 111 and 112 is the same as that in the sheet tray 110. Here, an operation when a user opens the sheet tray 110, stacks the sheets 302 on the sheet lifter plate 309, and closes the sheet tray 110 will be described.

### Lifting/Lowering Operation

FIG. 4 shows a graph of the drive speed and the operation time of the sheet lifter plate 309, showing control from the start of a lift-up operation after the tray is closed until the sheet 302 is stopped at the sheet surface position.

The vertical axis of the graph shown in FIG. 4 indicates the drive speed of the sheet lifter plate 309. 0 on the vertical axis indicates that the sheet lifter plate 309 is in a stopped state. The positive direction of the vertical axis indicates that the lift motor is rotated in the normal rotation direction, and indicates the speed when the sheet lifter plate 309 is lifted up. The negative direction of the vertical axis indicates that the lift motor is rotated in the reverse rotation direction, and indicates the speed when the sheet lifter plate 309 is lifted down.

The horizontal axis of the graph shown in FIG. 4 indicates the elapsed time during the lift-up operation. 0 on the horizontal axis indicates a timing at which the sheet tray 110 is closed.

T11 to T14 show side views showing the states of the sheet surface position detecting sensor 301 and the lower limit position detecting sensor 303 of the sheet tray 110 and the state of the sheets 302 in the sheet tray 110 at the respective time points.

The CPU 201 detects the closing of the sheet tray 110 by using the tray closing sensor. T11 shows the sensor states of the sheet surface position detecting sensor 301 and the lower limit position detecting sensor 303 immediately after the tray is closed.

Since the sheet lifter plate 309 is lowered to the lower limit position immediately after the tray is closed, the lower limit position detecting sensor 303 is turned on. Meanwhile, even in a case where the sheets 302 are stacked on the sheet lifter plate 309 until a fully loaded state is reached, the sheet surface position detecting sensor 301 is in an OFF state. As described with reference to FIG. 3A, the sheets 302 stacked on the sheet lifter plate 309 abut against the rear end regulating plate 310.

When the closing of the tray is confirmed, the sheet lifter plate 309 and the sheet 302 are moved to the sheet surface position. For this, the CPU 201 drives the lift motor in the normal rotation direction to operate the sheet lifter plate 309 at a first speed V1 (for example, 26.8 mm/sec), and lifts the sheet lifter plate 309. Such control for lifting the sheet lifter plate 309 at a high speed (first speed V1) is referred to as coarse lift-up as first lift-up.

Since the lift wire 311 slightly expands and contracts during the coarse lift-up operation, the sheet lifter plate 309 and the sheets 302 that are coarsely lifted up may vibrate. Due to the influence of vibrations, chattering of the sheet surface position detecting sensor 301 may occur. In order to correctly perform the subsequent operation even when the chattering occurs, after the sheet surface position detecting sensor 301 is turned on due to the coarse lift-up control, the coarse lift-up operation is continued for a certain period of time, and then the lift motor is stopped. The sensor state at this time is shown in T12.

T12 shows a sensor state after completion of the coarse lift-up. The sheets 302 stacked on the sheet lifter plate 309 turn on the sheet surface position detecting sensor 301. Meanwhile, since the coarse lift-up has been performed and the sheet lifter plate 309 has passed the lower limit position, the lower limit position detecting sensor 303 is in an OFF state. Since the lift motor continues the coarse lift-up operation for a certain period of time after the sheet surface position detecting sensor 301 is turned on, the uppermost sheet 317 of the sheets 302 stacked on the sheet lifter plate 309 moves to a position higher than the upper end portion of the rear end regulating plate 310.

After the coarse lift-up ends, the sheet surface of the uppermost sheet 317 is positioned. For this, the CPU 201 drives the lift motor in the reverse rotation direction to operate the sheet lifter plate 309 at the first speed (for example, -26.8 mm/sec), and lowers the sheet lifter plate 309. Such control for lowering the sheet lifter plate 309 at a high speed (first speed V1) is referred to as coarse lift-down as first lift-down.

During the coarse lift-down, chattering of the sheet surface position detecting sensor 301 may occur for the same reason as that during the coarse lift-up. Therefore, after the sheet surface position detecting sensor 301 is turned off, the lift motor continues the coarse lift-down operation for a certain period of time, and is then stopped. The sensor state at this time is shown in T13.

T13 shows a sensor state after completion of the coarse lift-down. The sheets 302 stacked on the sheet lifter plate 309 pass the sheet surface position detecting sensor 301, and the sensor is turned off. In addition, since the sheet lifter plate 309 does not reach the lower limit position even when it is lowered due to the coarse lift-down, the lower limit position detecting sensor 303 is also turned off. Since the uppermost sheet 317 of the sheets 302 stacked on the sheet lifter plate 309 returns to a position lower than the upper end portion of the rear end regulating plate 310, the sheet abuts against the rear end regulating plate 310.

After the coarse lift-down ends, in order to position the sheet surface of the uppermost sheet 317, the lift motor is driven in the normal rotation direction to operate the sheet lifter plate 309 at a second speed V2 (for example, 8.93 mm/sec) slower than the first speed V1, and the sheet lifter plate 309 is lifted. Such control for lifting the sheet lifter plate 309 at a low speed (second speed V2) is referred to as fine lift-up as second lift-up.

During the fine lift-up, the speed is slower than that during the coarse lift-up operation, and the amount of vibration due to expansion and contraction of the lift wire 311 is reduced, so that the detection of the sheet surface position is not affected. In order to accurately position the sheet surface of the uppermost sheet 317, the lift motor is stopped immediately after the sheet surface position detecting sensor 301 is turned on. The sensor state at this time is shown in T14.

T14 shows a sensor state after completion of fine lift-up. The sheets 302 stacked on the sheet lifter plate 309 are detected, and the sheet surface position detecting sensor 301 is turned on. In addition, the lower limit position detecting sensor 303 is turned off. The uppermost sheet 317 of the sheets 302 stacked on the sheet lifter plate 309 abuts against the rear end regulating plate 310 while remaining at a position lower than the upper end portion of the rear end regulating plate 310.

### Lifting/Lowering Operation In Case Where Paper Drag Occurs

FIG. 5 shows a graph of the drive speed and the operation time of the sheet lifter plate 309, showing control for a case where a lift-up operation is started after the tray is closed, and the sheets 302 stacked on the sheet lifter plate 309 are misaligned during the operation and lean against the rear end regulating plate.

The vertical axis of the graph shown in FIG. 5 indicates the drive speed of the sheet lifter plate 309. The graph can be read in the same way as in FIG. 4.

T21 to T23 show side views showing the states of the sheet surface position detecting sensor 301 and the lower limit position detecting sensor 303 of the sheet tray 110 and the state of the sheets 302 in the sheet tray 110 at the respective time points.

The CPU 201 detects the closing of the sheet tray 110 by using the tray closing sensor. T21 shows the sensor states of the sheet surface position detecting sensor 301 and the lower limit position detecting sensor 303 immediately after the tray is closed.

Since the sheet lifter plate 309 is lowered to the lower limit position immediately after the tray is closed, the lower limit position detecting sensor 303 is turned on. Meanwhile, even in a case where the sheets 302 are stacked on the sheet lifter plate 309 until a fully loaded state is reached, the sheet surface position detecting sensor 301 is in an OFF state. The sheets 302 stacked on the sheet lifter plate 309 abut against the rear end regulating plate 310.

When the closing of the tray is confirmed, the sheet lifter plate 309 and the sheet 302 are moved to the sheet surface position. For this, the CPU 201 drives the lift motor in the normal rotation direction to operate the sheet lifter plate 309 at the first speed V1 (for example, 26.8 mm/sec), and executes coarse lift-up to lift the sheet lifter plate 309.

Since the lift wire 311 slightly expands and contracts during the coarse lift-up operation, the sheet lifter plate 309 and the sheets 302 that are coarsely lifted up may vibrate. Due to the influence of vibrations, chattering of the sheet surface position detecting sensor 301 may occur. In order to correctly perform the subsequent operation even when the chattering occurs, after the sheet surface position detecting sensor 301 is turned on due to the coarse lift-up control, the coarse lift-up operation is continued for a certain period of time, and then the lift motor is stopped. The sensor state at this time is shown in T22.

T22 shows a sensor state after completion of the coarse lift-up. The sheets 302 stacked on the sheet lifter plate 309 turn on the sheet surface position detecting sensor 301. Meanwhile, since the coarse lift-up has been performed and the sheet lifter plate 309 has passed the lower limit position, the lower limit position detecting sensor 303 is in an OFF state. Since the lift motor continues the coarse lift-up operation for a certain period of time after the sheet surface position detecting sensor 301 is turned on, the uppermost sheet 317 of the sheets 302 stacked on the sheet lifter plate 309 moves to a position higher than the upper end portion of the rear end regulating plate 310. In this case, the uppermost sheet 317 may move in the direction of the rear end regulating plate 310 depending on the operation vibration of the sheet lifter plate 309 and the charging status between the stacked sheets 302.

After the coarse lift-up ends, the sheet surface of the uppermost sheet 317 is positioned. For this, the CPU 201 drives the lift motor in the reverse rotation direction to operate the sheet lifter plate 309 at the first speed (for example, -26.8 mm/sec), and executes coarse lift-down to lower the sheet lifter plate 309.

However, since the uppermost sheet 317 has moved toward the rear end regulating plate 310, the uppermost sheet 317 leans against the rear end regulating plate 310 when the sheet lifter plate 309 is lowered. In this state, since the sheet surface position detecting sensor 301 is not turned off, the lift motor is not stopped, the sheet lifter plate 309 continues to be lowered to the lower limit position, and the lower limit position detecting sensor 303 is turned on. When the sheet lifter plate 309 continues to be lowered in a state in which the lower limit position detecting sensor 303 is turned on, the lift wire 311 is loosened. Therefore, the lift motor is stopped at a time point when the lower limit position detecting sensor 303 is turned on. The sensor state at this time is shown in T23.

T23 shows a sensor state after completion of the coarse lift-down. The uppermost sheet 317 leans against the upper end portion of the rear end regulating plate 310, and the sheet surface position detecting sensor 301 remains ON even when the sheet lifter plate 309 is lowered. In addition, since the sheet lifter plate 309 continues to be lowered, the lower limit position detecting sensor 303 is also turned on.

After the coarse lift-down ends, fine lift-up is attempted to position the sheet surface of the uppermost sheet 317. However, since the sheet surface position detecting sensor 301 is turned on, the sheet lifter plate 309 is not lifted and remains in the state of T23. Even when the sheet separating mechanism separates the uppermost sheet 317 in this state, there is a concern that the separation may not be performed normally and a jam may occur.

### Example of UI Notification for Notification to User

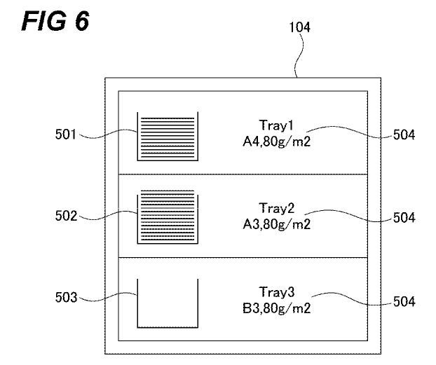

FIG. 6 is a diagram showing an example of UI display that notifies a user on the display panel 140. Here, the UI display displayed on the display panel 140 includes icons 501, 502, 503 and a tray information display region 504, and the status of the sheet trays 110, 111, and 112 is displayed in a list.

The icon 501 indicates a sheet stacking status in the sheet tray 110. Here, the icon 501 displays a first display indicating a status in which the sheets are stacked until a fully loaded state is reached.

The icon 502 indicates a sheet stacking status in the sheet tray 111. Here, the icon 502 indicates a case where overload has occurred. That is, the icon 502 displays a second display indicating a status in which the sheets are stacked more than full. In a case where both the sheet surface position detecting sensor 301 and the lower limit position detecting sensor 303 shown in FIG. 3A are turned on, the CPU 201 determines that overload has occurred. In a case where overload has occurred, the icon of the corresponding sheet tray is displayed by the second display. In addition, it is indicated that paper feeding is not possible, and opening of the corresponding sheet tray to check the status of the sheets 302 inside the tray is prompted.

As will be described later, as shown in T23, when the paper drag shown in T23 in FIG. 5 is detected in each of the sheet trays 110, 111, and 112, the UI display for notification to the user on the display panel 140 is the second display.

The icon 503 indicates a sheet stacking status in the sheet tray 112. Here, the icon 503 displays a third display indicating a status in which no sheets are stacked.

In the display of these icons, the color of the icon may be changed to indicate that paper feeding is not possible.

The tray information display region 504 shows setting information of the sheets 302 stacked in each of the sheet trays 110, 111, and 112. The tray number, the paper size, and the basis weight are displayed as the setting information. Here, Tray 1 represents the tray number of the sheet tray 110, Tray 2 represents the tray number of the sheet tray 111, and Tray 3 represents the tray number of the sheet tray 112. In addition, the surface properties, the paper shape (whether it is tab paper), and the like may be displayed.

### Flowchart for Sheet Surface Position Control

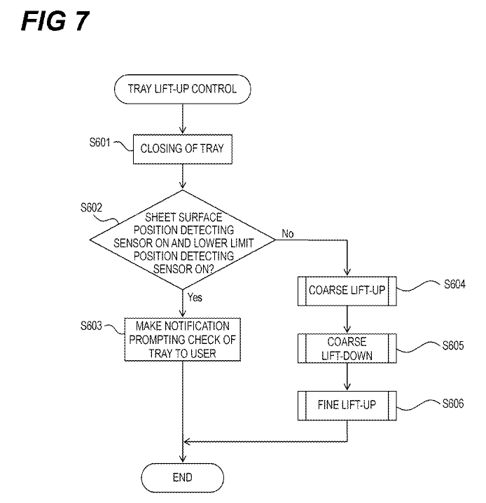

With reference to FIG. 7, sheet surface position control when the sheet tray 110 is closed with respect to the sheet feeder 101 in the sheet feeder 101 according to the present embodiment will be described. FIG. 7 is a flowchart showing an operation of the sheet feeder 101 according to the first embodiment. The sheet surface position control when the sheet trays 111 and 112 are closed is the same as in the sheet tray 110.

First, in S601, the CPU 201 detects the closing of the sheet tray 110 via the tray closing sensor.

Next, in S602, the CPU 201 checks the states of the sheet surface position detecting sensor 301 and the lower limit position detecting sensor 303 at a time when the closing of the sheet tray 110 is detected. In a case where it is detected that the state of the sheet surface position detecting sensor 301 is ON and the state of the lower limit position detecting sensor 303 is ON, it is determined that the sheets 302 are overloaded, and the process proceeds to S603. In a case where the sheets are not overloaded, that is, in a case where the state of the sheet surface position detecting sensor 301 is OFF and the state of the lower limit position detecting sensor 303 is ON, the process proceeds to S604.

Next, in S603, the CPU 201 notifies the controller through the device interface 209 that overload has occurred. The controller notifies a user that overload has occurred on the display device of the controller, and ends this flow.

Here, the CPU 201 notifies the controller included in the image forming apparatus connected to the sheet feeder 101, and displays that overload has occurred on a display device such as a touch panel display of the image forming apparatus. However, the present invention is not limited thereto, and for example, the CPU 201 may display that overload has occurred on the display panel 140 of the sheet feeder 101 or on the display devices of both of the sheet feeder 101 and the image forming apparatus.

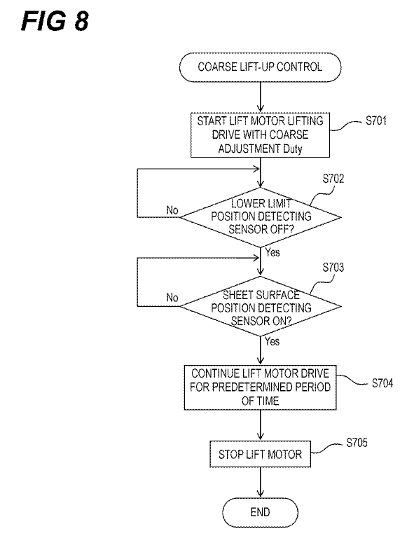

Next, in S604, the CPU 201 performs coarse lift-up control in which the drive portion 206 is driven in the normal rotation direction to lift the sheet lifter plate 309 from the lower limit position at the first speed and the sheets 302 stacked on the sheet lifter plate 309 are moved to the feeding position. The details of the coarse lift-up control will be described with the flowchart (see FIG. 8) for coarse lift-up to be described later. When the coarse lift-up control S604 ends, the process proceeds to S605.

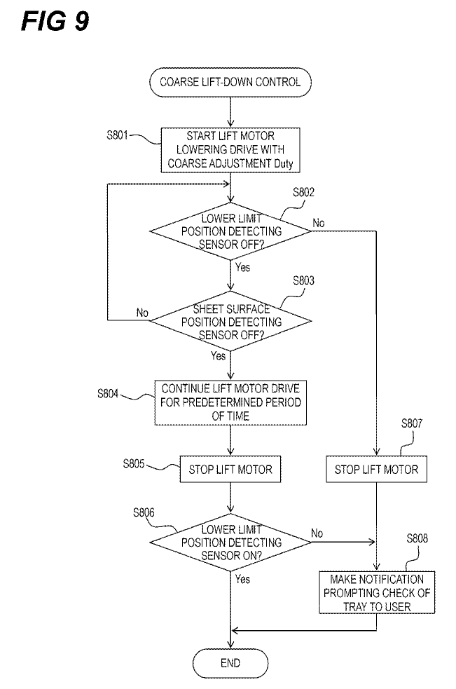

Next, in S605, the CPU 201 performs coarse lift-down control in which the drive portion 206 is driven in the reverse rotation direction after the coarse lift-up control to lower the sheet lifter plate 309 at the first speed and the sheets 302 stacked on the sheet lifter plate 309 are moved below the sheet surface position. The details of the coarse lift-down control will be described with the flowchart (see FIG. 9) for coarse lift-down to be described later. When the coarse lift-down control S605 ends, the process proceeds to S606.

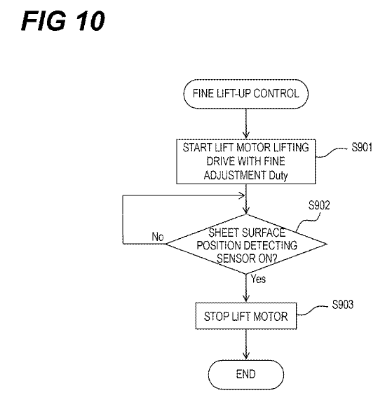

Next, in S606, the CPU 201 performs fine lift-up control in which the drive portion 206 is driven in the normal rotation direction after the coarse lift-down control to lift the sheet lifter plate 309 at the second speed slower than the first speed and the sheets 302 stacked on the sheet lifter plate 309 are moved to the sheet surface position. The details of the fine lift-up control will be described with the flowchart (see FIG. 10) for fine lift-up to be described later. When the fine lift-up control S606 ends, this flow ends.

Here, regarding the sheet surface position control when the sheet tray 110 is closed with respect to the sheet feeder 101, a configuration has been exemplified in which the sheet lifter plate 309 is lifted from the lower limit position at the first speed (S604), the sheet lifter plate 309 is lowered at the first speed (S605), and the sheet lifter plate 309 is lifted at the second speed (S606), but the present invention is not limited thereto.

First, in S604, the CPU 201 performs coarse lift-up control in which the drive portion 206 is driven at the first speed to lift the sheet lifter plate 309 from the lower limit position to the sheet surface position.

Next, in S605, the CPU 201 performs coarse lift-down control in which the drive portion 206 is driven at the first speed after the coarse lift-up control to lower the sheet lifter plate 309 below the sheet surface position.

Next, in S606, the CPU 201 performs fine lift-up control in which the drive portion 206 is driven at the second speed slower than the first speed after the coarse lift-down control to lift the sheet lifter plate 309 to the sheet surface position.

The sheet surface position control when the sheet tray 110 is closed with respect to the sheet feeder 101 may be performed as described above.

A configuration has been exemplified in which, in S605, the CPU 201 drives the drive portion 206 at the first speed when performing the coarse lift-down control, but the drive speed of the drive portion 206 is not limited thereto.

In addition, in the above-described sheet surface position control, a configuration has been exemplified in which, in the coarse lift-up control and the fine lift-up control, the CPU 201 rotates the lift motor of the drive portion 206 in the normal rotation direction that is the first direction, and in the coarse lift-down control, the CPU 201 rotates the lift motor in the reverse rotation direction that is the second direction opposite to the first direction, but the rotation direction of the lift motor is not limited thereto in each control.

### Flowchart for Coarse Lift-Up

With reference to FIG. 8, control when the coarse lift-up in S604 of FIG. 7 is performed will be described. FIG. 8 is a flowchart for a case where the lifter plate is subjected to coarse lift-up.

In S701, the CPU 201 instructs the drive portion 206 to perform lift-up control. In this case, the drive speed of the lift motor of the drive portion 206 is set to a duty for coarse control (for example, 100%) to perform lift-up. Therefore, the sheet lifter plate 309 starts lifting at a coarse adjustment speed (first speed).

Next, in S702, the CPU 201 detects the lower limit position detecting sensor 303 until the sheet lifter plate 309 is lifted and the lower limit position detecting sensor 303 is turned off. When the lower limit position detecting sensor 303 is turned off, the process proceeds to S703.

Next, in S703, the CPU 201 detects the sheet surface position detecting sensor 301 until the sheet lifter plate 309 is lifted and the sheet surface position detecting sensor 301 that detects the stacked sheets 302 is turned on. When the sheets 302 are detected and the sheet surface position detecting sensor 301 is turned on, the process proceeds to S704.

Next, in S704, the CPU 201 sets a predetermined waiting time (for example, 37 milliseconds), and continues drive of the lift motor of the drive portion 206.

Next, in S705, the CPU 201 detects that the predetermined waiting time set in S704 has elapsed, stops the lift motor of the drive portion 206, and ends this flow.

### Flowchart for Coarse Lift-Down

With reference to FIG. 9, control when the coarse lift-down control in S605 of FIG. 7 is performed will be described. FIG. 9 is a flowchart for a case where the lifter plate is subjected to coarse lift-down.

In S801, the CPU 201 instructs the drive portion 206 to perform lift-down control. In this case, the drive speed of the lift motor of the drive portion 206 is set to a duty for coarse control (for example, 100%) to perform lift-down. Therefore, the sheet lifter plate 309 starts lowering at a coarse adjustment speed (first speed).

Next, in S802, the CPU 201 checks that the sheet lifter plate 309 is lowered and the lower limit position detecting sensor 303 remains OFF. When the lower limit position detecting sensor 303 remains OFF, the process proceeds to S803. When the lower limit position detecting sensor 303 is turned on, the process proceeds to S807.

Next, in S803, the CPU 201 checks that the sheet lifter plate 309 is lowered and the sheet surface position detecting sensor 301 is turned off due to the lowering of the sheets 302. When the sheet surface position detecting sensor 301 is turned off, the process proceeds to S804. When the sheet surface position detecting sensor remains ON, the process proceeds to S802.

Next, in S804, the CPU 201 sets a predetermined waiting time (for example, 117 milliseconds), and continues drive of the lift motor of the drive portion 206.

Next, in S805, the CPU 201 detects that the predetermined waiting time set in S804 has elapsed, and stops the lift motor of the drive portion 206.

Next, in S806, the CPU 201 checks the lower limit position detecting sensor 303 again after stopping the lift motor of the drive portion 206, and ends this flow when the lower limit position detecting sensor 303 remains in an OFF state. Meanwhile, when the lower limit position detecting sensor 303 is checked again and is in an ON state after stopping the lift motor of the drive portion 206, it is determined that it is necessary to check the internal status of the sheet tray 110 (such as abnormality of the sheet stacking status), and the process proceeds to S808.

Next, when the lower limit position detecting sensor 303 is turned on in S802, the CPU 201 stops the lift motor of the drive portion 206 in S807.

Next, in S808, the CPU 201 notifies the controller through the device interface 209. The controller makes a notification prompting the user to check the sheet tray on the display device of the controller, and ends this flow.

In this case, the CPU 201 notifies the controller included in the image forming apparatus connected to the sheet feeder 101, and provides a display prompting a check of the sheet tray on a display device such as a touch panel display of the image forming apparatus. However, the present invention is not limited thereto, and for example, the CPU 201 may provide a display prompting a check of the sheet tray on the display panel 140 (see FIG. 6) of the sheet feeder 101 or on the display devices of both of the sheet feeder 101 and the image forming apparatus.

In addition, in a case where the CPU 201 provides a display prompting a check of the sheet tray on the display panel 140 (see FIG. 6) of the sheet feeder 101 in S808, the information to be notified to the user may be the same as the notification of overload. For example, similarly to the overload shown in FIG. 6, the information to be notified to the user displays the icon 502 (second display) indicating a status in which the sheets are stacked more than full as a display prompting a check of the sheet stacking status inside the sheet tray.

In this way, after closing the sheet tray and before starting feeding, it is possible to previously eliminate a state in which feeding cannot be normally performed by making a notification prompting a check of an internal status of the sheet tray.

### Flowchart for Fine Lift-UP

With reference to FIG. 10, control when the fine lift-up in S606 of FIG. 7 is performed will be described. FIG. 10 is a flowchart for a case where the lifter plate is subjected to fine lift-up.

In S901, the CPU 201 instructs the drive portion 206 to perform lift-up control. In this case, the drive speed of the lift motor of the drive portion 206 is set to a duty for fine control (for example, 33%) to perform lift-up. Therefore, the sheet lifter plate 309 starts lifting at a fine adjustment speed (second speed) slower than the coarse adjustment speed (first speed).

In this way, due to the lift-up at the fine adjustment speed (second speed) slower than the coarse adjustment speed (first speed), the sheet surface is at a predetermined height, and thus it is possible to suppress double feeding and a jam of sheets due to the height of the sheet surface being equal to or higher than the predetermined height.

Next, in S902, the CPU 201 detects the sheet surface position detecting sensor 301 until the sheet lifter plate 309 is lifted and the sheet surface position detecting sensor 301 that detects the stacked sheets 302 is turned on. When the sheets 302 are detected and the sheet surface position detecting sensor 301 is turned on, the process proceeds to S903.

Next, in S903, the CPU 201 stops the lift motor of the drive portion 206 and ends this flow.

As described above, according to the present embodiment, when the above-described control is performed in sequence, in a case where both the sheet surface position detecting sensor 301 and the lower limit position detecting sensor 303 are in a detection state during execution of the coarse lift-down control, a notification is made prompting a check of the internal status of the sheet tray. In this way, it is possible to previously eliminate a state in which feeding cannot be normally performed by making a notification prompting a check of the internal status of the sheet tray. For example, when the sheets 302 have leaned against the rear end regulating plate 310 during the lift-up control of the sheet tray, this can be detected during the coarse lift-down control, and the user can be prompted to open and check the corresponding sheet tray. Therefore, the abnormal state occurring in the sheet trays 110, 111, and 112 can be appropriately eliminated, so that the occurrence of a jam can be prevented in advance.

### Second Embodiment

In a second embodiment, an example will be described of control for opening a sheet tray in a case where both a sheet surface position detecting sensor as a first detecting portion and a lower limit position detecting sensor as a second detecting portion are in a detection state during coarse lift-down control. By opening the sheet tray, a user is notified of the occurrence of paper drag on the sheets stacked in the sheet tray.

### Flowchart for Sheet Surface Position Control

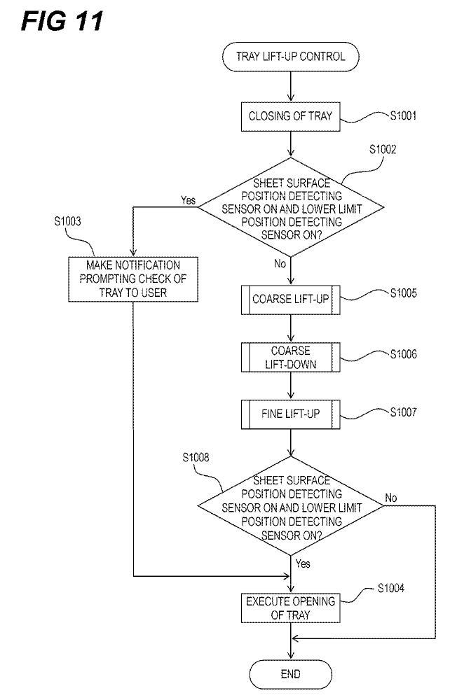

With reference to FIG. 11, sheet surface position control when a sheet tray 110 is closed in a sheet feeder 101 according to the second embodiment will be described. FIG. 11 is a flowchart showing an operation of the sheet feeder 101 according to the second embodiment. The sheet surface position control when sheet trays 111 and 112 are closed is the same as in the sheet tray 110.

First, in S1001, a CPU 201 detects the closing of the sheet tray 110 via a tray closing sensor.

Next, in S1002, the CPU 201 checks the states of a sheet surface position detecting sensor 301 and a lower limit position detecting sensor 303 at a time when the closing of the sheet tray 110 is detected. In a case where it is detected that the state of the sheet surface position detecting sensor 301 is ON and the state of the lower limit position detecting sensor 303 is ON, it is determined that sheets 302 are overloaded, and the process proceeds to S1003. In a case where the sheets are not overloaded, that is, in a case where the state of the sheet surface position detecting sensor 301 is OFF and the state of the lower limit position detecting sensor 303 is ON, the process proceeds to S1005.

Next, in S1003, the CPU 201 notifies the controller through a device interface 209 that overload has occurred. The controller notifies a user that overload has occurred on the display device of the controller.

Here, the CPU 201 notifies the controller included in the image forming apparatus connected to the sheet feeder 101, and displays that overload has occurred on a display device such as a touch panel display of the image forming apparatus. However, the present invention is not limited thereto, and for example, the CPU 201 may display that overload has occurred on a display panel 140 of the sheet feeder 101 or on the display devices of both of the sheet feeder 101 and the image forming apparatus.

Next, in S1004, for the sheet tray in which overload has been detected, the CPU 201 turns on a solenoid of the corresponding sheet tray by a tray opening/closing portion 213, opens the sheet tray, and ends this flow.

Next, in S1005, the CPU 201 performs coarse lift-up control in which a drive portion 206 is driven in the normal rotation direction to lift a sheet lifter plate 309 from the lower limit position at the first speed and the sheets 302 stacked on the sheet lifter plate 309 are moved to the feeding position. Since the details of the coarse lift-up control are the same as the flowchart for coarse lift-up shown in FIG. 8, a description thereof will be omitted here. When the coarse lift-up control S1005 ends, the process proceeds to S1006.

Next, in S1006, the CPU 201 performs coarse lift-down control in which the drive portion 206 is driven in the reverse rotation direction after the coarse lift-up control to lower the sheet lifter plate 309 at the first speed and the sheets 302 stacked on the sheet lifter plate 309 are moved below the sheet surface position. Since the details of the coarse lift-down control are the same as the flowchart for coarse lift-down shown in FIG. 9, a description thereof will be omitted here. When the coarse lift-down control S1006 ends, the process proceeds to S1007.

Next, in S1007, the CPU 201 performs fine lift-up control in which the drive portion 206 is driven in the normal rotation direction after the coarse lift-down control to lift the sheet lifter plate 309 at the second speed slower than the first speed and the sheets 302 stacked on the sheet lifter plate 309 are moved to the sheet surface position. Since the details of the fine lift-up control are the same as the flowchart for fine lift-up shown in FIG. 10, a description thereof will be omitted here. When the fine lift-up control S1007 ends, the process proceeds to S1008.

Next, in S1008, the CPU 201 checks that the state of the sheet surface position detecting sensor 301 is ON and the state of the lower limit position detecting sensor 303 is ON. In a case where it is detected that the sheet surface position detecting sensor 301 and the lower limit position detecting sensor 303 are turned on, it is determined that the sheets 302 are overloaded, and the process proceeds to S1004. In a case where it is not possible to detect that the sheet surface position detecting sensor 301 and the lower limit position detecting sensor 303 are turned on, this flow ends.

Here, regarding the sheet surface position control when the sheet tray 110 is closed with respect to the sheet feeder 101, a configuration has also been exemplified in which the sheet lifter plate 309 is lifted from the lower limit position at the first speed (S604), the sheet lifter plate 309 is lowered at the first speed (S605), and the sheet lifter plate 309 is lifted at the second speed (S606), but the present invention is not limited thereto.

The sheet surface position control when the sheet tray 110 is closed with respect to the sheet feeder 101 may be performed in the same manner as in the above-described first embodiment by controlling the drive speed (first speed and second speed) of the drive portion 206 and sequentially performing the coarse lift-up control, the coarse lift-down control, and the fine lift-up control.

As described above, according to the present embodiment, when the above-described control is performed in sequence, in a case where both the sheet surface position detecting sensor 301 and the lower limit position detecting sensor 303 are in a detection state during execution of the coarse lift-down control, a notification is made prompting a check of the internal status of the sheet tray, and the corresponding sheet tray is opened. In this way, it is possible to previously eliminate a state in which feeding cannot be normally performed by making a notification prompting a check of the internal status of the sheet tray and opening the corresponding sheet tray. For example, when the sheets 302 have leaned against the rear end regulating plate 310 during the lift-up control of the sheet tray, this can be detected during the coarse lift-down control, and the user can be prompted to open and check the corresponding sheet tray. Therefore, the abnormal state occurring in the sheet trays 110, 111, and 112 can be appropriately eliminated, so that the occurrence of a jam can be prevented in advance.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-066285, filed Apr. 14, 2025, which is hereby incorporated by reference herein in its entirety.

What is claimed is:

1. A sheet feeding apparatus comprising:
a storage portion configured to store a sheet;
a feeding portion configured to feed the sheet stored in the storage portion;
a stacking portion that can be lifted or lowered and on which the sheet stored in the storage portion is stacked;
a first detecting portion configured to detect that the sheet stacked on the stacking portion is at a feeding position at which the sheet is fed by the feeding portion;
a second detecting portion configured to detect that the stacking portion is at a lower position lower than the feeding position;
a drive portion for lifting or lowering the stacking portion; and
a controller configured to control the drive portion based on detection results of the first detecting portion and the second detecting portion,
wherein the controller executes a first lift-up operation of lifting the stacking portion from the lower position to the feeding position at a first speed,
a first lift-down operation of lowering the stacking portion below the feeding position after the first lift-up operation, and
a second lift-up operation of lifting the stacking portion to the feeding position at a second speed slower than the first speed after the first lift-down operation, and
wherein in a case where the first detecting portion and the second detecting portion are in a detection state when the first lift-down operation is executed, the controller notifies to confirm the sheet to be stacked in the stacking portion.

2. A sheet feeding apparatus comprising:
a storage portion configured to store a sheet;
a feeding portion configured to feed the sheet stored in the storage portion;
a stacking portion that can be lifted or lowered and on which the sheet stored in the storage portion is stacked;
a first detecting portion configured to detect that the sheet stacked on the stacking portion is at a feeding position at which the sheet is fed by the feeding portion;
a second detecting portion configured to detect that the stacking portion is at a lower position lower than the feeding position;
a drive portion for lifting or lowering the stacking portion; and
a controller configured to control the drive portion based on detection results of the first detecting portion and the second detecting portion,
wherein the controller executes a first lift-up operation of lifting the stacking portion from the lower position to the feeding position by driving the drive portion at a first speed,
a first lift-down operation of lowering the stacking portion below the feeding position after the first lift-up operation, and
a second lift-up operation of lifting the stacking portion to the feeding position by driving the drive portion at a second speed slower than the first speed after the first lift-down operation, and
wherein in a case where the first detecting portion and the second detecting portion are in a detection state when the first lift-down operation is executed, the controller makes a notification prompting a check of an internal status of the storage portion.

3. The sheet feeding apparatus according to claim 2,
wherein the controller drives the drive portion at the first speed to lower the stacking portion below the feeding position when the first lift-down operation is performed.

4. The sheet feeding apparatus according to claim 2,
wherein the drive portion is a motor, and
the controller rotates the motor in a first direction in the first lift-up operation and the second lift-up operation, and rotates the motor in a second direction opposite to the first direction in the first lift-down operation.

5. The sheet feeding apparatus according to claim 1, further comprising:
a display portion,
wherein the controller provides a display prompting a check of an internal sheet stacking status of the storage portion on the display portion in making the notification prompting a check.

6. The sheet feeding apparatus according to claim 5,
wherein the controller displays, on the display portion, any one of a first display indicating a status in which sheets are stacked until a fully loaded state is reached, a second display indicating a status in which sheets are stacked more than full, and a third display indicating a status in which no sheets are stacked as the display prompting a check of an internal sheet stacking status of the storage portion, and
the controller displays the second display in making the notification prompting a check.

7. The sheet feeding apparatus according to claim 1,
wherein a plurality of the storage portions is provided,
an opening/closing portion configured to open and close the storage portion is further provided, and
in making the notification prompting a check, the controller drives the opening/closing portion, and executes an operation of opening a storage portion in which the first detecting portion and the second detecting portion are in a detection state when the first lift-down operation is executed.

8. The sheet feeding apparatus according to claim 1, wherein the feeding portion is provided in an upper portion of the storage portion, and includes a conveying belt configured to suck and convey an uppermost sheet floated by blowing air to the sheet stored in the storage portion.

9. The sheet feeding apparatus according to claim 1, wherein a rear end regulating portion configured to regulate an end portion on an upstream side in a feeding direction of the sheet stacked on the stacking portion, and a side regulating portion configured to regulate a position of an end portion in a width direction orthogonal to the feeding direction of the sheet stacked on the stacking portion are provided.

10. An image forming apparatus comprising:
the sheet feeding apparatus according to claim 1; and
an image forming portion configured to form an image on a sheet fed by the sheet feeding apparatus.
